(19) United States
(12) Patent Application Publication
(10) Pub. No.: US 2007/0068688 A1
(43) Pub. Date: Mar. 29, 2007

(54) Vertical cultivator

(76) Inventor: Douglas G. Bruce, Perry, IA (US)

Correspondence Address: STURM & FIX LLP, 206 SIXTH AVENUE, SUITE 1213, DES MOINES, IA, 50309-4076, US

(21) Appl. No.: 11/237,122

(22) Filed: Sep. 28, 2005

(51) Int. Cl. A01D 15/00

(52) U.S. Cl. 172/15

(57) ABSTRACT

The present invention provides a retrofit system for replacing the shovels on existing, outdated tillage equipment with coulters. Such tillage equipment includes cultivators and field cultivators. An advantage provided by the coulters is their use in high crop residue conditions. Where shanks with shovels can become clogged with crop residue, coulters will cut through the crop residue while providing tillage. One or more coulters are attached to each shank from which a shovel was removed.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

This invention relates to tillage tools and, more particularly, to a retrofit cultivator attachment.

2. Background Art

As shown in FIG. 1, common cultivation equipment used today and in the past is fitted with shanks 110—either spring shanks or rigid shanks—each having a shovel 120 fitted to the lower end thereof. The shovel 120 is significantly wider than it is tall, and cuts a wide swath without disturbing the soil significantly in the vertical direction.

Today, much of the farming done is “no-till” or “minimum tillage.” With these methods, much of the crop residue from a previous year's crop is left on the surface of the field. Cultivation equipment from years past is not made to be used with significant residue on the surface. Use of such equipment will result in large amounts of crop residue building up in front of the shanks 110.

A method of dealing with surface residue is to use disks or coulters, providing vertical cultivation, slicing through the surface residue.

A device designed for cultivation between rows of crops and using disks is shown in FIG. 2. This cultivator was not particularly popular, and does not offer a retrofit for existing cultivation equipment.

For seedbed preparation, a disk harrow is shown in FIG. 3. These devices were and are popular in some parts of the United States. Disk harrows are used to chop crop residue and incorporate it into the soil. However, disk harrows of today do not provide a retrofit for existing cultivation equipment.

Old cultivation equipment remains unused on farms. There is, therefore, a need for an improved cultivation device providing vertical cultivation and providing a retrofit to existing equipment.

### BRIEF SUMMARY OF THE INVENTION

The present invention provides a solution for the above need. A simple retrofit device, for replacing the shovels of outdated cultivation equipment with coulters capable of providing tillage in high surface crop residue conditions, is presented. A mandrel, attachable to an existing cultivator shank, whether a spring shank or a rigid shank, in place of the shovel provides a pivot for the one or more coulters rotatably attached thereto.

The coulters may be flat or wavy coulters. Often a pair of coulters is operatively rotatably attached to each shank, but the present invention is not limited to pairs of coulters.

The axle of the mandrel is rigid, so the axes of rotation of the pair of coulters, when a plurality of coulters are attached to a mandrel, are in fixed relationship one to another.

An object of the present invention is the provision of a tillage device for high surface crop residue conditions.

Another object is to provide a retrofit system to convert outdated tillage devices to equipment useful in modem no- or low-till farming situations.

### BRIEF DESCRIPTION OF THE SEVERAL VIEWS OF THE DRAWINGS

FIG. 1 is a perspective view of a spring shank with a prior art shovel attached thereto;

FIG. 2 is a perspective view of a disk cultivator;

FIG. 3 is a perspective view of a disk harrow of the prior art;

FIG. 4 is a perspective view of a cultivator spring shank and a retrofit coulter adaptor therefor.

FIG. 5 is a perspective view of a sleeve bearing portion of a retrofit mandrel;

FIG. 6 is a plan view of a sleeve bearing portion of a retrofit mandrel;

FIG. 7 is a perspective view of a cultivator assembly; and

FIG. 8 is a plan view of a sleeve bearing portion of a retrofit mandrel specifically for a single coulter application.

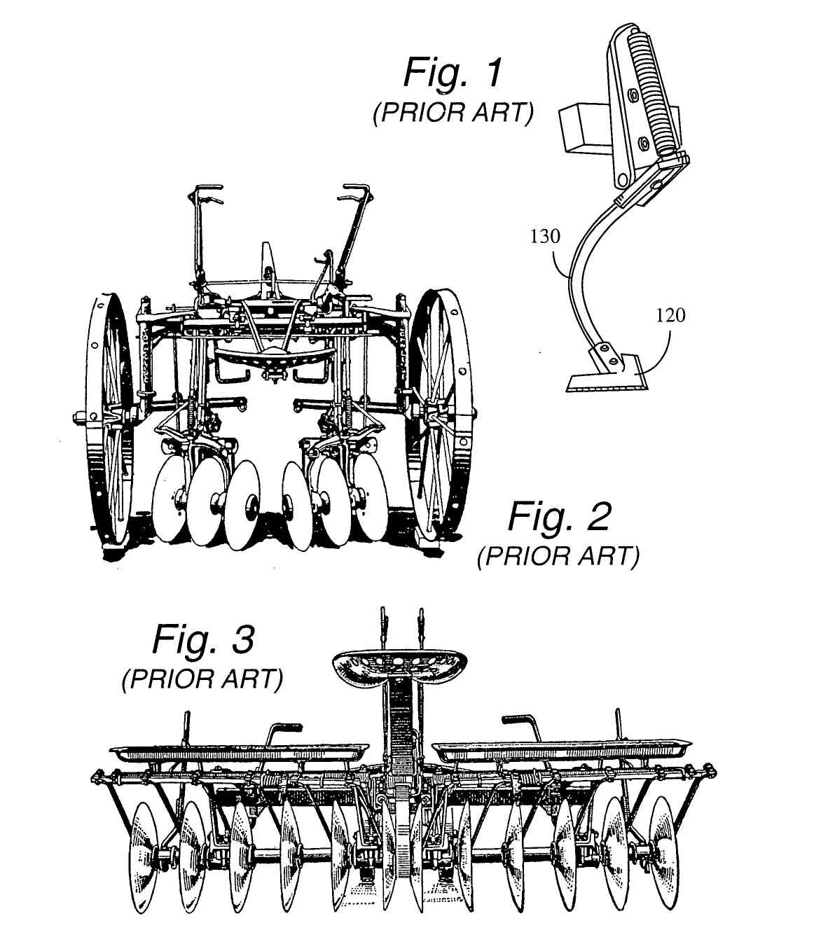

### DETAILED DESCRIPTION OF THE INVENTION

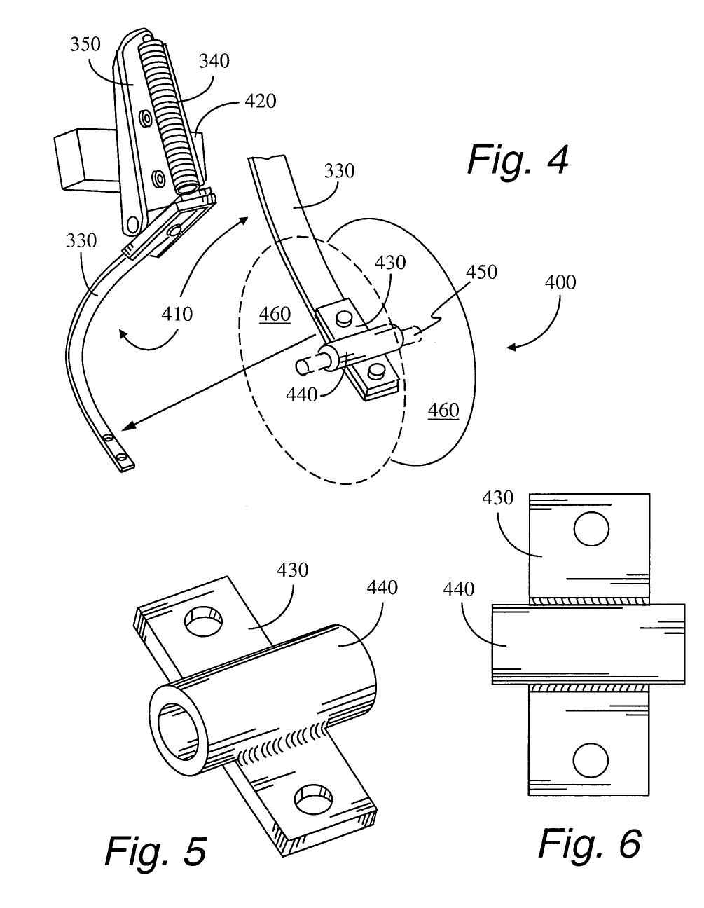

Referring now to the drawings, wherein like reference numerals designate identical or corresponding parts throughout the several views, FIGS. 4-6 show a retrofit coulter assembly 400 for existing cultivator equipment.

The spring shank assembly 410 shown in FIG. 4 is attached to a beam 420 on an agricultural implement. Examples of such implements include cultivators and field cultivators. The retrofit coulter assembly 400 comprises a plate 430, a bearing assembly 440, a shaft 450, and at least one coulter 460. The spring shank assembly comprises a shank 330, a spring 340, and a bracket 350.

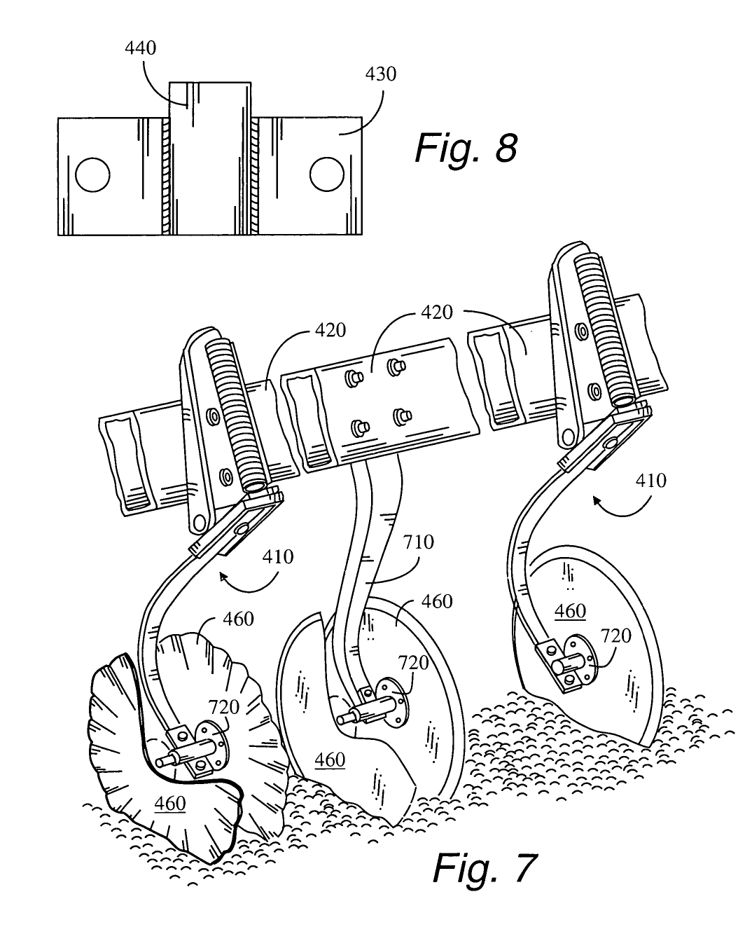

The plate 430 is bolted, riveted, welded or otherwise affixed to the shank 330, which may be a spring shank 330 shown, or a rigid shank 710 as shown in FIG. 7. To the plate 430 is affixed the bearing assembly 440. Preferably, the housing of the bearing assembly 440 will be welded to the plate 430 as shown in FIGS. 5-6. The bearing assembly 440 may comprise a housing and separate bearings (not shown), or simply a sleeve bearing, as shown in FIGS. 5-6.

A shaft 450 is rotatably engaged in the bearing assembly 440. Attached to or integral with the shaft 450 are preferably flanges 720 as shown in FIG. 7, to which the coulters 460 are affixed. Preferably, the flanges 720 will be riveted or bolted to the coulters 460.

As shown in FIG. 7, the coulters 460 may be wavy or flat. A combination of wavy and flat coulters 460 may be used on a single implement and even a single shank 330, 710. Coulters 460 may be used in conjunction with traditional shovels on the same implement.

The rightmost spring shank in FIG. 7 has only a single coulter. A variation on the mandrel of FIGS. 5-6 is shown in FIG. 8 for use with a single coulter.

Obviously, many modifications and variations of the present invention are possible in light of the above teachings. It is therefore to be understood that, within the scope of the appended claims, the invention may be practiced otherwise than as specifically described.

I claim:

1. A method of providing a retrofit coulter assembly for existing cultivation equipment, the coulter assembly comprising a mandrel and a coulter, the method comprising:
(a) removing existing shovels from the existing cultivation equipment;
(b) operatively attaching the mandrel to the existing cultivation equipment in place of the removed shovels; and
(c) operatively rotatably attaching the coulter to the mandrel, thereby retrofitting the existing cultivation equipment with the coulter.

2. The method of claim 1 wherein removing the existing shovels comprises removing the existing shovels from shanks on the existing cultivation equipment.

3. The method of claim 1 wherein operatively attaching the mandrel to the existing cultivation equipment comprises attaching the mandrel to shanks on the existing cultivation equipment.

4. The method of claim 1 additionally comprising operatively rotatably attaching a second coulter to the mandrel.

5. The method of claim 1 wherein operatively attaching the mandrel to the existing cultivation equipment comprises:
(a) operatively, rigidly affixing a bearing assembly to a plate;
(b) operatively, rotatably engaging a shaft to the bearing assembly; and
(c) operatively, rigidly affixing the plate to the existing cultivation equipment.

6. A method of retrofitting existing tillage equipment, said equipment originally comprising shovels, said method comprising replacing the shovels with coulters.

7. The method of claim 6 additionally comprising:
(a) removing the shovels from the existing tillage equipment;
(b) operatively, rotatably affixing the coulters to the tillage equipment at locations from which the shovels were removed.
